(19) United States
(12) Patent Application Publication
(10) Pub. No.: US 2006/0117059 A1
(43) Pub. Date: Jun. 1, 2006

(54) System and method for monitoring and managing performance and availability data from multiple data providers using a plurality of executable decision trees to consolidate, correlate, and diagnose said data

(75) Inventors: Jimmy Donald Freeman JR., Houston, TX (US); Svetlana Kryukova, Houston, TX (US)

Correspondence Address: Tim Shen, Attorney at Law, Suite 106, 14125 Memorial Dr., Houston, TX, 77079, US

(73) Assignee: Tidal Software, Inc.

(21) Appl. No.: 11/213,549

(22) Filed: Aug. 26, 2005

Related U.S. Application Data
(60) Provisional application No. 60/631,905, filed on Nov. 30, 2004.

(51) Int. Cl. G06F 7/00

(52) U.S. Cl. 707/102

(57) ABSTRACT

The invention monitors and manages performance and availability data from multiple data providers. A set of executable hierarchical decision trees is used. Each tree has an anchor data node that, if matched to an incoming data point, will trigger the execution of the decision tree. Each tree has lower level data nodes that may request data when the data nodes are traversed during the execution of the tree. Each data node request a particular type of data to be received within a certain time window. Depending on the availability and analysis of the data, the node will return a result, causing the decision tree to proceed and branch the hierarchical decision tree according to the result, if necessary. At the end of each tree branch is an action node, which represents the correlation of an alert, event, or performance metric. The path of the anchor node, data nodes, and action node followed in the executable hierarchical decision tree are used to generate a correlation event. The system allows a single system operator to monitor the applications and operating system, filters out irrelevant data, and allows data to be processed asynchronously.

### CROSS-REFERENCE TO RELATED APPLICATIONS

This invention was originally disclosed in Provisional Application No. 60/631,905 filed on Nov. 30, 2004. The inventor claims all rights and priorities associated with the provisional application.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

In today's enterprise computing environment, there are many applications that need constant monitoring and managing. One such application is the SAP database. There are many products in the marketplace that can monitor SAP, including a monitoring tool from SAP called CCMS, which will report various types of monitoring data, e.g., alerts, status, performance metrics.

There are various products available to monitor the data, but none has the ability to capture and process data asynchronously, consolidate data from multiple sources, correlate the data, identify root causes, report correlated alerts, events and performance data, and make recommendations to the system operator. A few examples of prior art products include: Quest: Foglight, BMC Software: Patrol for SAP, Veritas, HP: OpenView, Calif.: Unicenter, Tivoli, and SAP CCMS.

There are several problems facing application monitoring today. First, too much monitoring information is sent to the operator. Additionally, too many applications are sending information at one time and there are too many consoles to monitor at the same time. Also, there are not enough experienced operators/administrators to review all the data generated by the various applications. Application monitoring does not correlate data from multiple sources and applications. Finally, application monitoring can't determine root causes of problems from all the information.

The invention provides a way to consolidate the data from multiple sources; analyze and correlate data using existing expert knowledge, know-how and experience, i.e., create an “expert-in-a-box” approach; filter out unnecessary data points; provide meaningful alerts and performance information to the operator; and provide recommendations based on correlated alerts, events, and performance data.

### BRIEF SUMMARY OF THE INVENTION

The invention monitors and manages performance and availability data from multiple data providers. A set of executable hierarchical decision trees is used. Each tree has an anchor data node that, if matched to an incoming data point, will trigger the execution of the decision tree. Each tree has lower level data nodes that may request data when the data nodes are traversed during the execution of the tree. Each data node request a particular type of data to be received within a certain time window. Depending on the availability and analysis of the data, the node will return a result, causing the decision tree to proceed and branch the hierarchical decision tree according to the result, if necessary. At the end of each tree branch is an action node, which represents the correlation of an alert, event, or performance metric. The path of the anchor node, data nodes, and action node followed in the executable hierarchical decision tree are used to generate a correlation event.

At startup time, all the correlation trees are loaded into the system and the attributes of the data nodes are known. As data from the data providers come in, a preliminary match of data to data nodes may be made. If there is a match, the data will be held in a data holding bin awaiting a request from an executing correlation tree. Data points that match a correlation tree are tagged with a lifespan, which is used to determine how long the data points will be maintained in the data holding bin. Once the lifespan has expired and no executing correlation tree is matched with the data point, the data point will be discarded.

When an anchor node matches a particular event a correlation tree is activated and the tree begins execution. As the system proceeds down the tree and traverses a data node, the data node will request data and wait for data. If the requested data is available, the data node will analyze the data and output a result. If the data is not available, the data node will output a different result indicating the absence of data. Depending on the result of the analysis or the availability of the data, the tree will continue execution and perform a branch, if necessary.

When an action node is reached at the end of a tree branch, a correlation of data points has occurred, and a correlation event is issued. A diagnostic report is also generated and provided to the system operator. The decision reached on the trees represents knowledge and expertise on how to analyze data points from the various data sources. Each tree is customized to represent certain types of alerts, events, or performance metrics, and the data nodes on the tree are used to analyze particular data associated with such alerts, events, or performance metrics.

In addition, the data points corresponding to a correlated alert, event or performance metric may occur out of chronological order or asynchronously, unlike the prior art. In other words, the relevant data points do not have to occur in any particular chronological order so long as they occur during a pre-defined time window. This allows for the capturing of relevant data even before an event occurs that would trigger the capturing of such data. This is also referred to as “Fuzzy Time” processing of data.

The invention consolidates data points from multiple data sources to analyze the data and correlates the data from multiple sources. It handles the data “asynchronously” reporting only relevant events and recommends courses of action and diagnostic reports. The invention improves over the prior art by allowing monitoring at the operating system level, application and database level, and network performance and connectivity level. The system provides consolidated view of data, and reduces data traffic to operator; i.e., reduce “noise” at the console

The system performs data correlation and root cause analysis, and provides proactive analysis of data instead of merely reacting to incoming data. It enables execution of daily system/application checklists; provides 24 hour and 7 day a week support; and minimizes outages and Service Level Agreement exceptions.

### BRIEF DESCRIPTION OF THE SEVERAL VIEWS OF THE DRAWINGS

The above objects and advantages of the present invention will become more apparent by describing in detail a preferred embodiment thereof with reference to the attached drawings in which:

FIG. 1A illustrates a computing enterprise environment that monitors multiple applications and operating systems using multiple system consoles;

FIG. 1B illustrates a computing enterprise environment that monitors multiple applications and operating systems using a single system console;

FIG. 2 is a flow chart illustrating a method for monitoring and managing performance and availability data from multiple data providers;

FIG. 3 illustrates the steps performed in monitoring and managing performance and availability data from multiple data providers;

FIG. 4A illustrates a correlation tree flow chart;

FIG. 4B is a flow chart illustrating the execution logic performed by a data node;

FIG. 5A illustrates a correlation tree;

FIG. 5B illustrates an ideal time line of data received;

FIG. 5C illustrates a real world time line of data received;

FIG. 5D illustrates a correlation tree with requested data attributes, time windows data, and time window reference node;

FIG. 5E is a flow chart showing how data is initially processed and matched;

FIG. 5F illustrates data points in the data holding bin;

FIG. 6A illustrates the system architecture;

FIG. 6B illustrates another embodiment of the invention;

FIG. 7A illustrates a screen shot of a correlation tree;

FIG. 7B illustrates a definition of the correlation tree;

FIG. 7C illustrates a diagnostic report;

FIG. 8 illustrates a listing of the correlation trees currently implemented in the product.

### DETAILED DESCRIPTION OF THE INVENTION

Glossary

“Asynchronous Time” (or “Fuzzy Time”) refers to the concept that data points associated with an event may occur out of order with respect to chronological time. For example, an event A may have three data points associated with it: X, Y, and Z. However, the data points may occur in any order, such as X, Z, and Y or Z, X, and Y. Under the “Fuzzy Time” approach, the order of the data point occurrence is not important, so long as they occur within a specified time window, and once the three data points have occurred, event A is reported.

C# (“C sharp”) is the programming language used to implement the invention. C# is part of the Dot NET (.NET) programming package provided by the Microsoft Corporation.

CCMS is a monitoring system provided with a SAP database. CCMS provides the following types of data: alerts, performance values, and status attributes.

A correlation event refers to a set of data points that has been identified and associated with a specific alert, event, or performance metric. In other words, the data has been correlated, which might be (1) a correlated alert (also referred to as a Correlex Alert), (2) a correlated event (also referred to as a Correlex Event), or (3) a correlated performance data (also referred to as a Correlex Performance Data or Metric).

Correlation tree refers to the executable hierarchical decision tree as implemented in the present invention.

“Correlex” is a trademark of Tidal and is used to refer to the innovative technology of using a plurality of executable decision trees to analyze data.

Data provider (also referred to as a data source) can be any application, system, or program that provides data that may generate alerts, events, performance metrics or any other information. One example of a data provider is CCMS.

Decision tree refers to the well-known hierarchical decision tree having multiple levels of nodes. Each level has data nodes and branches to lower level nodes.

Microsoft Operations Manager (MOM) refers to a system framework offered by Microsoft Corp.

SAP, as used herein, refers to a database marketed by the well-known database solution company, SAP AG.

Tree instance refers to an active decision tree, i.e., a tree that has been started and is currently executing.

In the computing enterprise environment, there are multiple applications and operating systems running and sharing resources with each other. The applications and systems are sending status messages, alerts, and performance data to multiple consoles, often flooding and overrunning such consoles with excessive information and making it very difficult for systems operators to respond. Moreover, with excessive information, the operator has difficulty distinguishing minor alerts from critical problems and events.

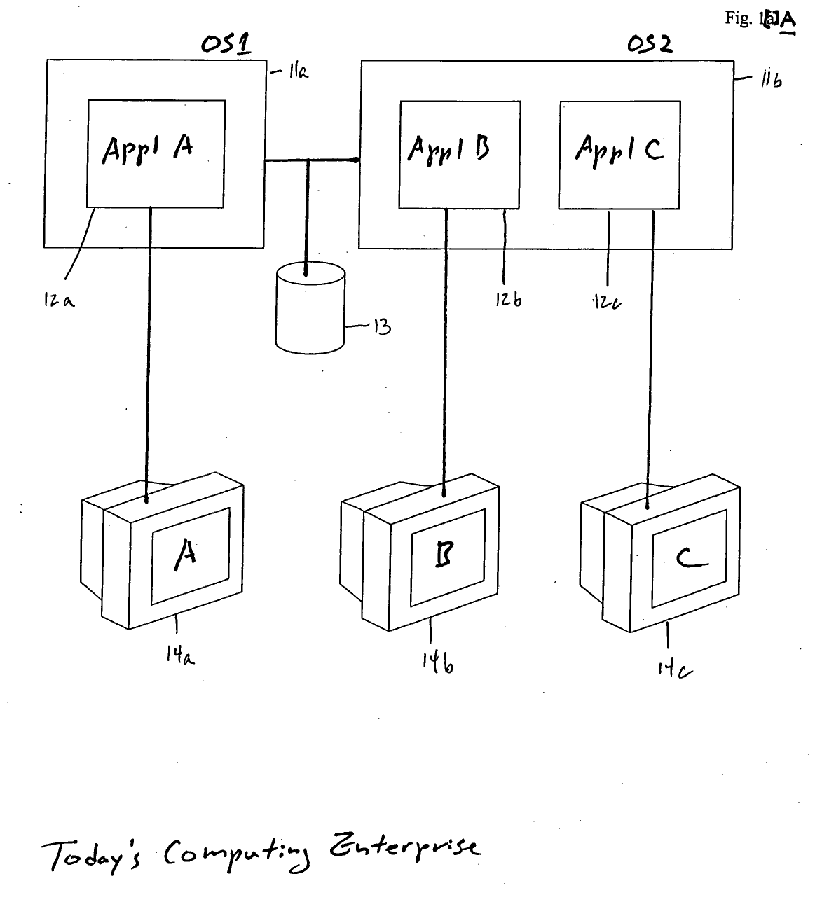

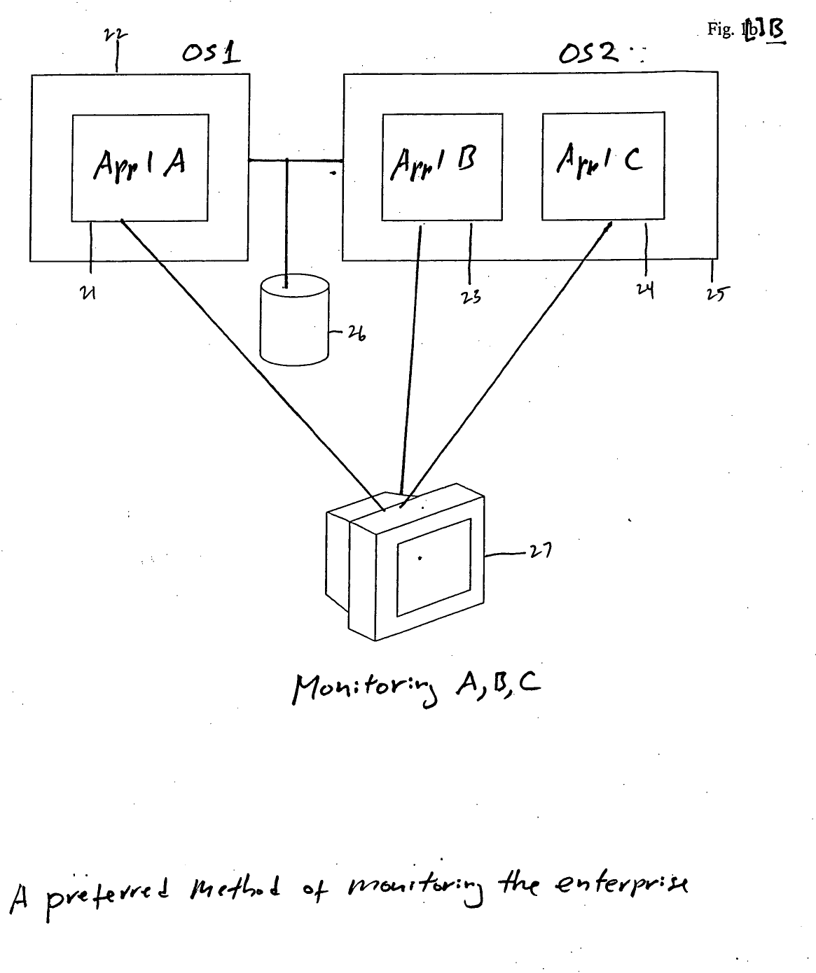

In FIG. 1A, application A 12a is running on operating system OS1 11a, which communicates with operating system OS2 11b where application B 12b and application C 12c are running. OS1 11a and OS2 11b communicate with each other and share certain storage resources. Each application has a monitoring console where alerts and status are reported. In such environment, a problem on one operating system or application can affect the other operating system or applications in the computing environment. For example, if application B 12b is using an excessive amount of shared storage, it can cause slowdown on OS1 11a and OS2 11b, thereby affecting the performance of application A 12a and application C 12c. The system also has a storage device 13. While application B 12b may report the storage usage problem to its console 14b, the system operators for application A 12a and application C 12c will not receive the report on the console for application A 14a and the console for application C 14c.

As shown in FIG. 1B, the present invention provides a method for monitoring data from multiple data sources or providers in a computing enterprise by consolidating and analyzing all the data together, thereby maintaining the context and interdependent nature of the data from the various data sources. While a performance slowdown condition from one source may not be significant, when analyzed with data from other sources it may indicate a greater problem in the overall computing enterprise. Analysis and correlation of data from multiple sources will yield great accuracy and insight in the monitoring and management of the computing enterprise. The system can monitors Application A 21 on OS1 22 and Application B 23 and Application C 24 on OS2 25. The system also has a storage device 26. The multiple sources are monitored by a single console 27.

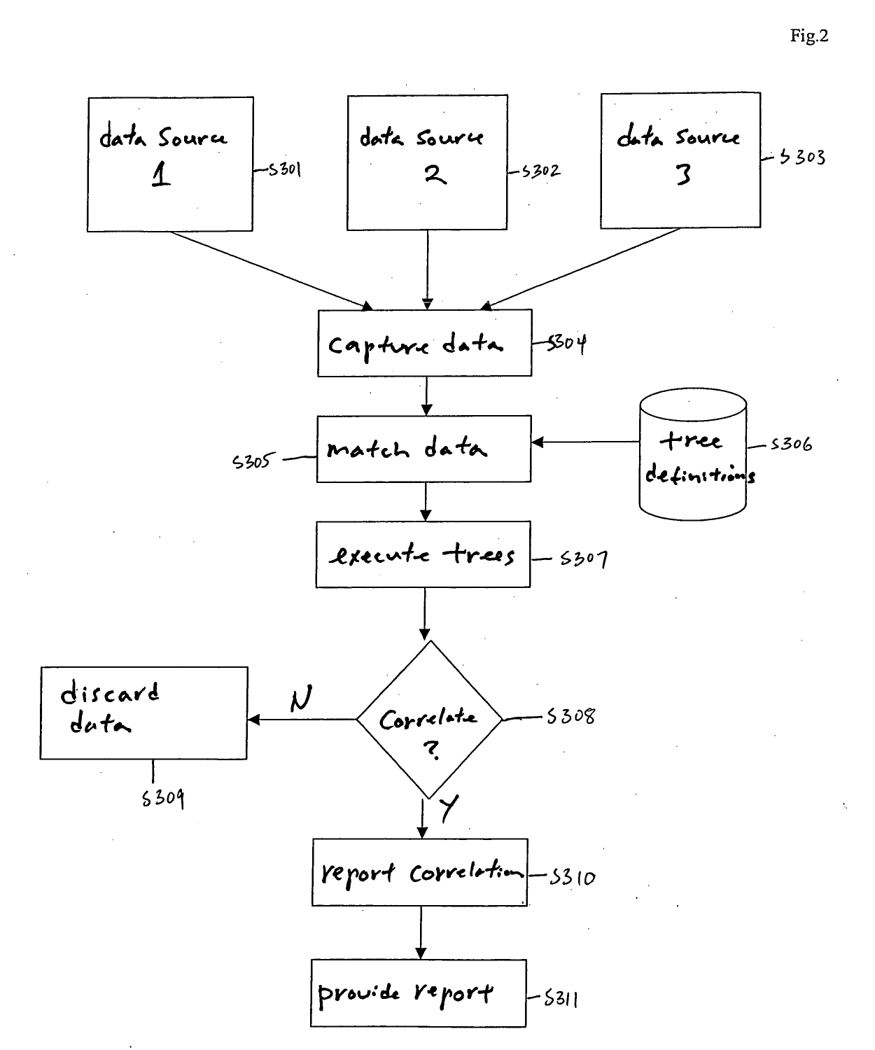

The present invention can monitor data points from multiple data sources as shown in FIG. 2. First, data points from the multiple data sources S301, S302, S303 are captured and processed together S304. The data points are matched against data attributes S305 in the decision tree definitions S306. These decision trees are called correlation trees. Upon matching of certain data points, a correlation tree will begin execution S307 and the data nodes will perform data requests and analysis. An analysis is performed to check if the incoming data correlates S308 with all the data definitions associated with data nodes of the decision tree. When the incoming data matches all the data definitions associated with data nodes of the decision tree, then a correlation event is reported to the operator S310. However, if the data points do not meet the criteria of the data nodes, then the data points may be deleted S309 and no correlation is reported. The deletion of data points will reduce the amount of data traffic to an operator. When a correlation event is reported to an operator, the associated diagnostic report S311 is provided to give additional information and recommendations to the operator.

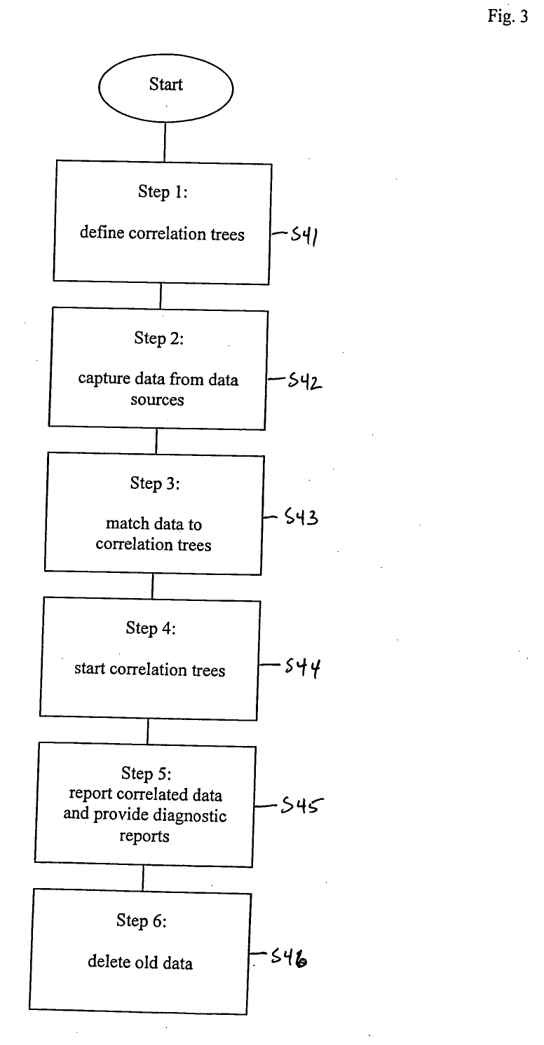

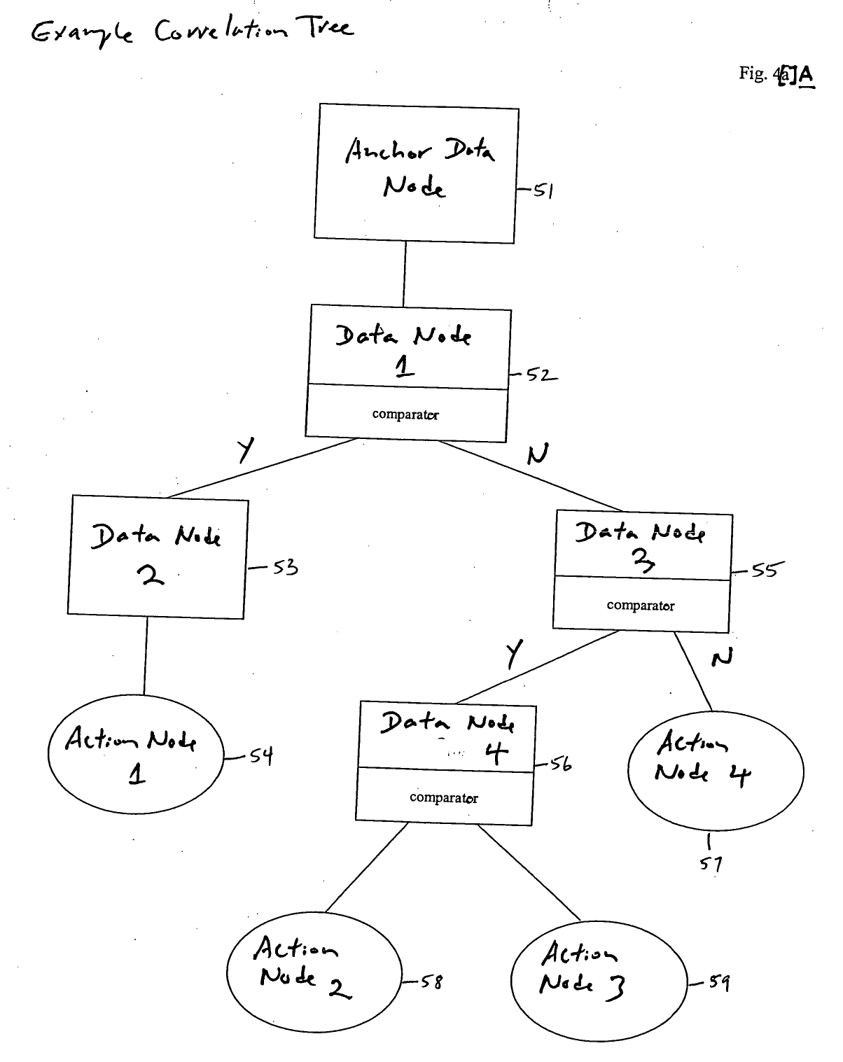

In FIG. 3 a flow chart illustrating the key steps performed by the system is shown. Step 1: Define correlation trees S41. A correlation tree is an executable hierarchical decision tree having one or more levels of nodes and branches. There are three types of nodes on a correlation tree: anchor data nodes, lower level data nodes, and action nodes. An anchor data node is the first node of a correlation tree. The anchor node defines certain data attributes, and if the incoming data point matches such attributes, then the tree will begin executing. Each lower level data node, herein referred to as a data node, can perform data requests and analysis of data. An action node is at the end of a tree branch and is used to report a correlated alert, event, or performance metric. Correlation trees embody the know-how and experience associated with diagnosing alerts, problems, or events for an application or system. For example, if the system to be monitored is a SAP system, then the experience and know-how of a person skilled in SAP management would be implemented in the correlation trees.

Step 2: Capture data points from the data sources S42. For example, if SAP is being monitored, the data from CCMS will be captured by the invention. All the data points from the data sources being monitored are captured and processed together.

Step 3: Match data points to the data nodes in the correlation trees S43. As data points are captured, they are matched to the correlation trees loaded in the system. If any of the data points match any of the data nodes of the correlation trees, the data points will be tagged as “of interest” and held in waiting until requested by a correlation tree.

Step 4: Start execution of certain correlation trees S44. Each correlation tree has an anchor data node. If an incoming data point matches the anchor data node of a correlation tree, then the tree becomes a “tree instance” and the correlation tree is started. Once started, the tree begins executing by traversing the data nodes as it moves down the tree. Each traversed data node will request specific data and wait for the data to become available. Depending on the availability and analysis of the data, a data node will output a particular result, which will determine how the tree will branch and continue down the tree. Once an action node is reached at the end of a tree branch, a correlation of data will occur and a diagnostic report and will be generated. The diagnostic report may also include additional data.

Step 5: Report correlated data and recommend a course of action S45. When an action node is reached, then all the data associated with an alert, event or performance metric has occurred. At this point, a correlation event is reported, along with a diagnostic report to provide additional information and recommendations to the system operator.

Step 6: Clean up “old” data S46. Data points that are not used by the data tree or have expired are deleted on a routine basis. “Old” data is not reported in order to reduce the amount of unnecessary information to the system operator. However, if desired, certain defaults can be changed so that “old” data is reported to the operator.

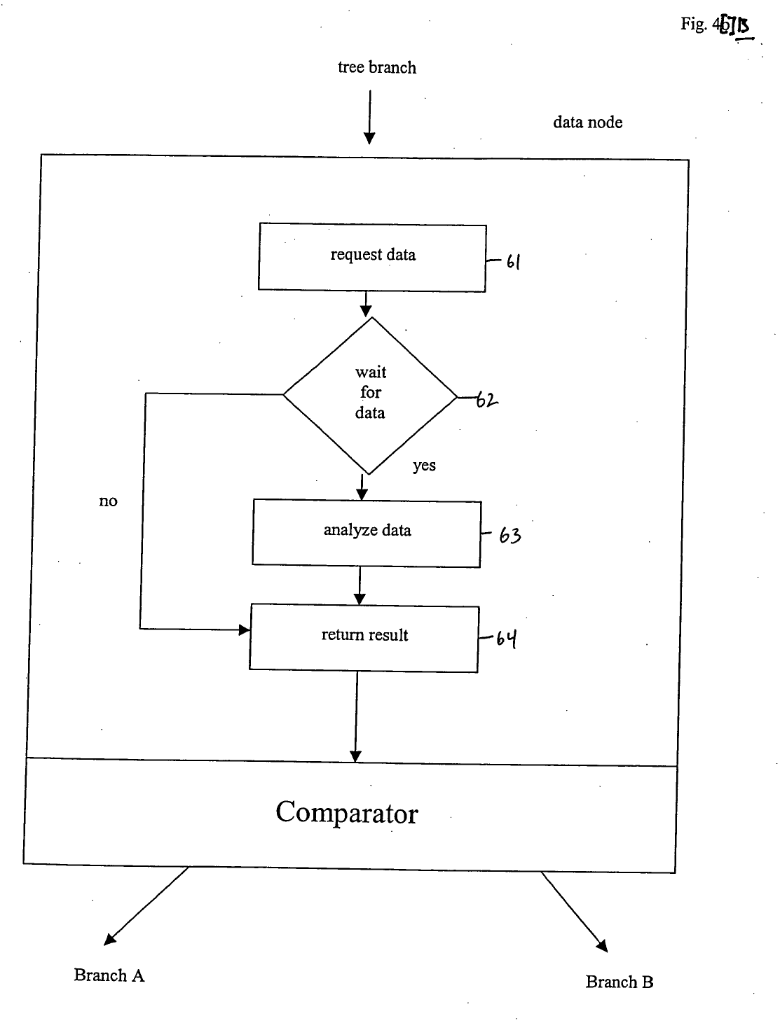

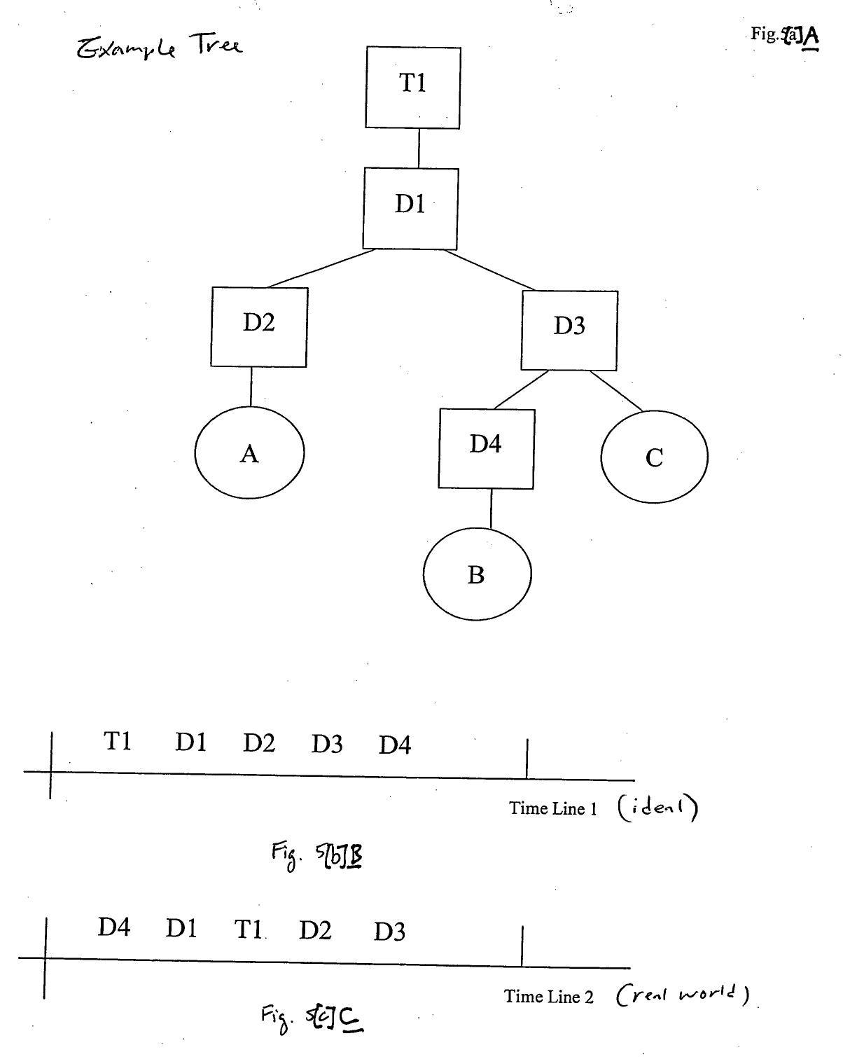

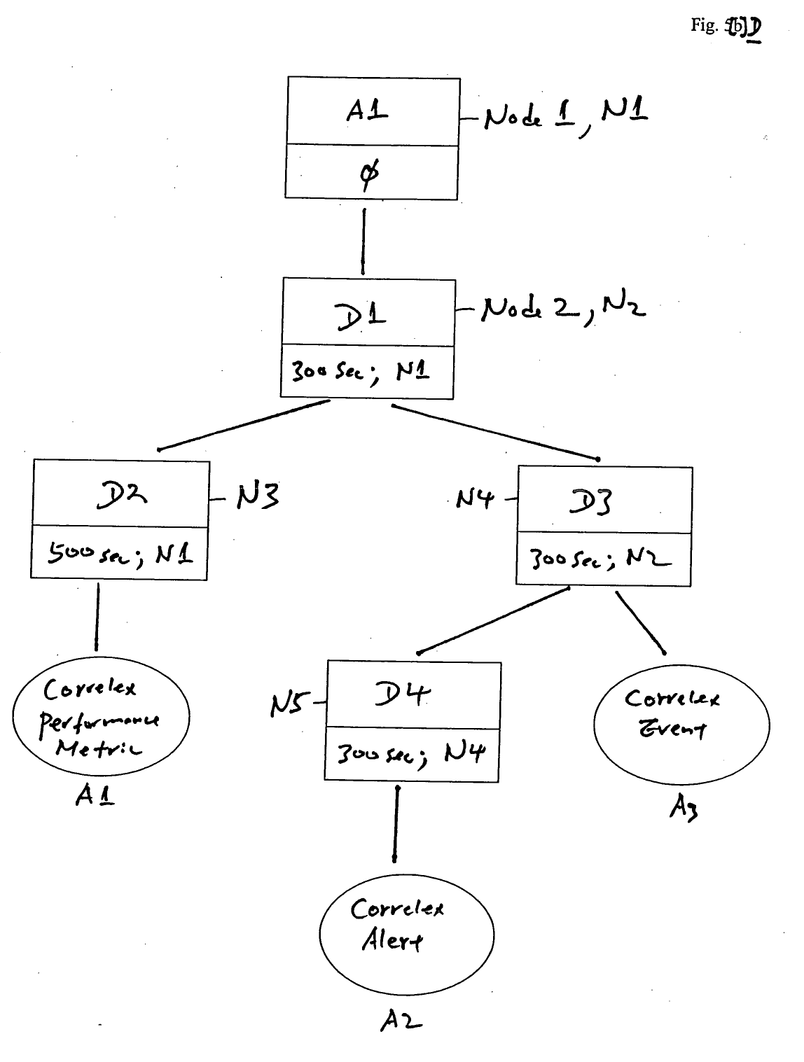

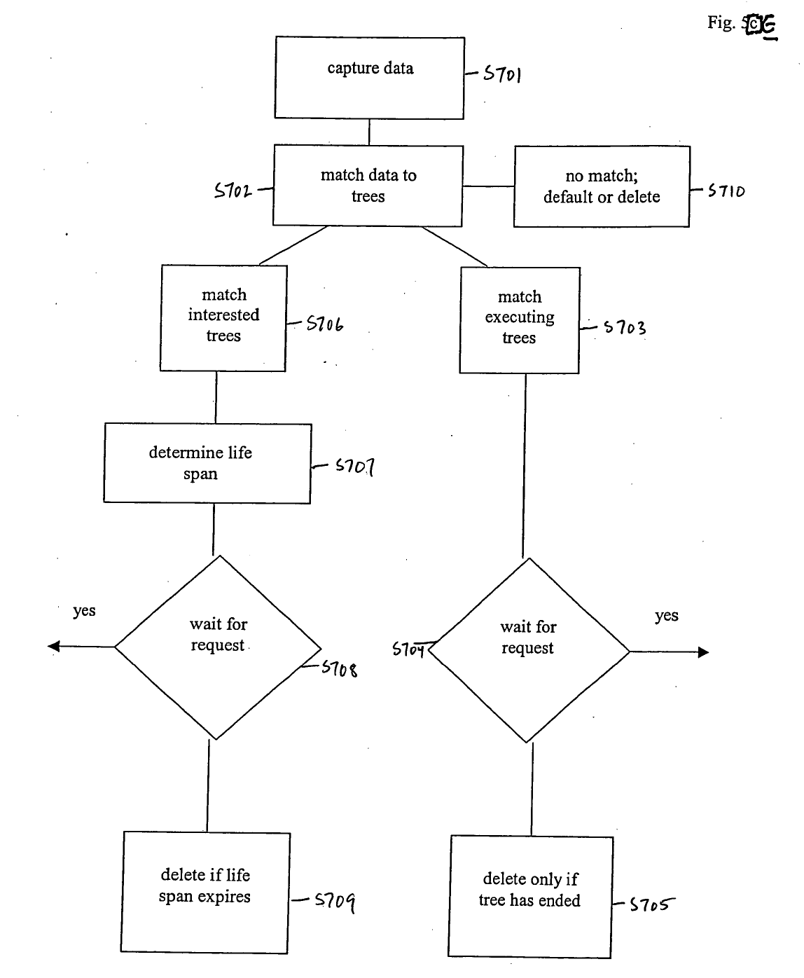

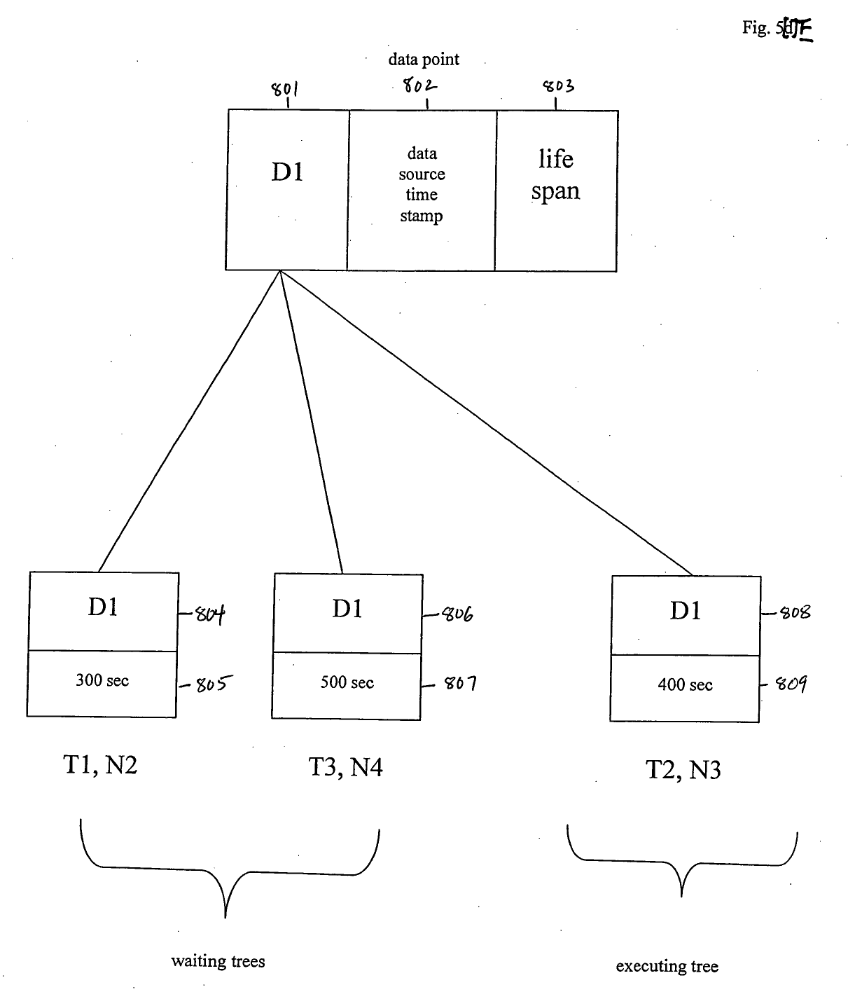

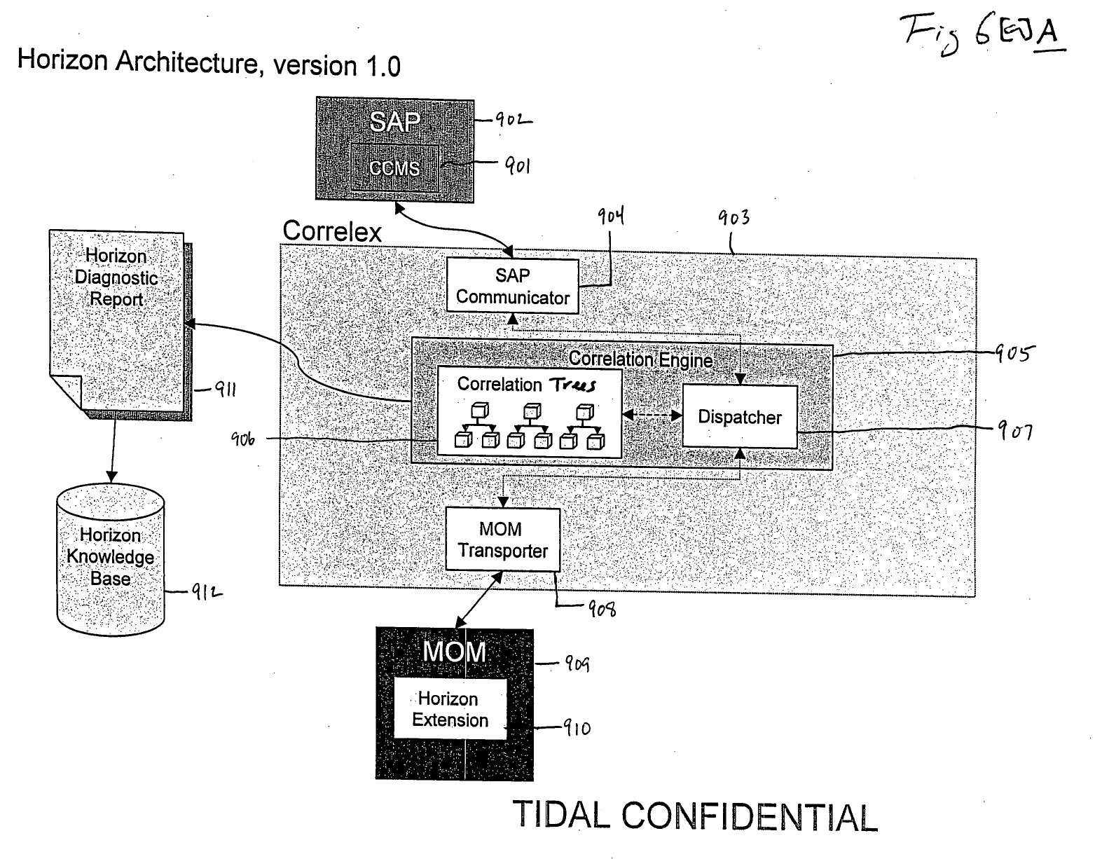

An example correlation tree is shown in FIG. 4A. A correlation tree has an anchor node and one or more lower-level data nodes. Some data nodes have comparators, which will examine the result of the data node's analysis to determine which way to branch in the correlation tree to the next level of nodes. In FIG. 4A, data nodes 1 51, node 3 55, and node 4 56 have comparators associated with them. Depending on the result of the data analysis performed by the data node, a particular branch will be taken. For example, the result of the data analysis performed by data node 1 52 determines if the system proceeds to data node 2 53 or to data node 3 55. Each tree branch eventually ends with an action node, which is used to indicate a correlation event, such as a correlated alert, event, or performance metric. Once an action node has been reached, a tree will stop execution and terminate normally.

For example, in FIG. 4A, there is an anchor node. If an incoming data matches the anchor node 51, then the tree is activated. The tree then proceeds to data node 1 52. Data node 1 52 will request a particular data, wait for the requested data, analyze the requested data and output a result. The comparator of data node 1 52 will branch according to the output. If the output is yes, then the tree will proceed to execute data node 2 53. To illustrate, data node 1 52 may request a certain data X and then wait for it. If data X is not available after waiting a certain time interval, the data node will output a result and cause the comparator to branch to data node 3 55. On the other hand, if data X is available, the tree will continue to data node 2 53. Data node 2 53 may request additional status information associated with data X and then proceed directly to action node 1 54, which will report that a correlation event in the form of an alert, event, or performance metric has occurred. Similarly, action node 2 58, action node 3 59, and action node 4 57 will report that a correlation event in the form of an alert, event, or performance metric has occurred. In addition, a diagnostic report will be provided with the correlation data to further inform the system operator as to the analysis of the data and to recommend a course of action.

Not all incoming data points will result in a correlation. Some data will not match any data nodes, and other data, which match data nodes of interest, will not be used because the interested tree may not execute at all or the particular branch of the matched tree instance did not execute. Some matched data points will not be used because of the lifespan associated with the data points will expire.

Every correlation tree definition contains one or more data node definitions. Each data node definition contains, among other things: (1) data attributes of the requested data, (2) the source of the data, and (3) the time window and the time window reference node. A data node executes only if its correlation tree is executing and the data node has been traversed. In FIG. 4B, a data node is traversed by a correlation tree and starts execution. The data node will request certain data 61 and then wait for it 62. If the requested data is not available within a specified time window and relative to the timestamp of a reference node, then the data node will return a result 64. If the data is available, then the data node will analyze the data 63 and return a result 64. Depending on the result, a comparator will determine which way to branch down the tree. Some data nodes do not branch and will proceed directly to the next data node or to an action node.

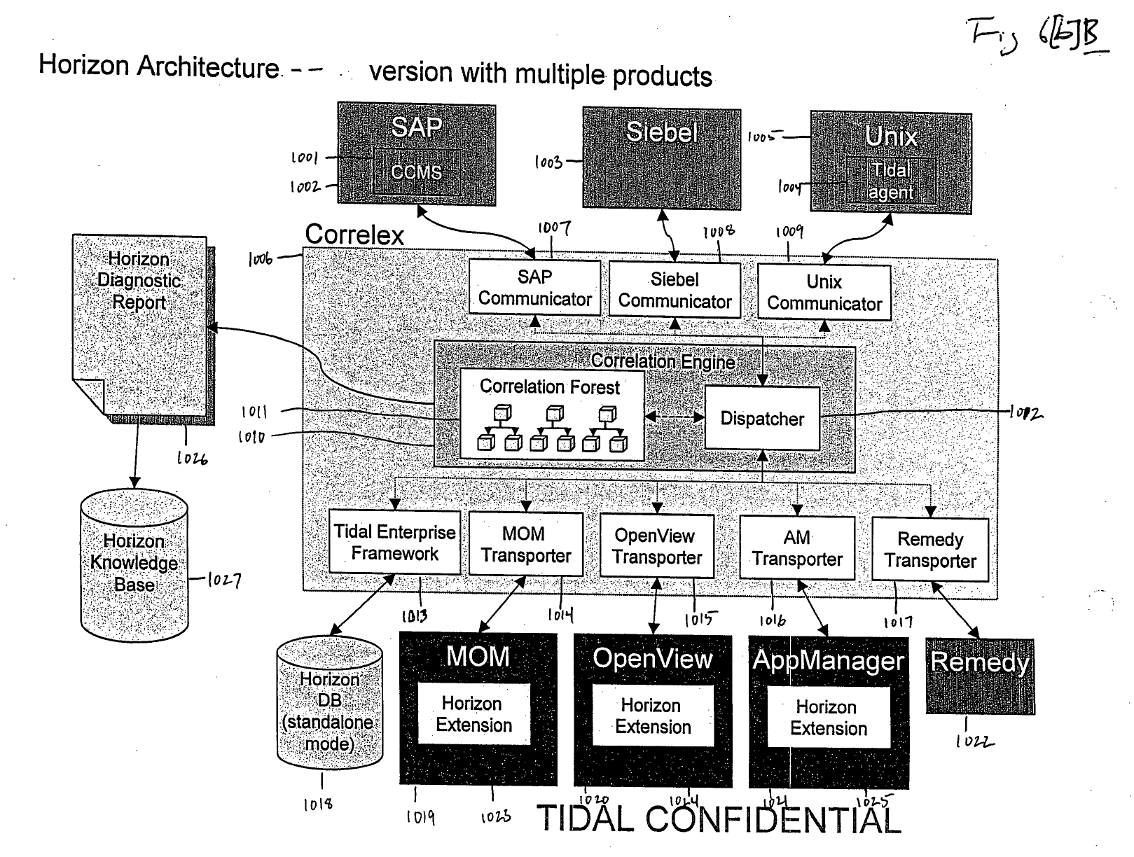

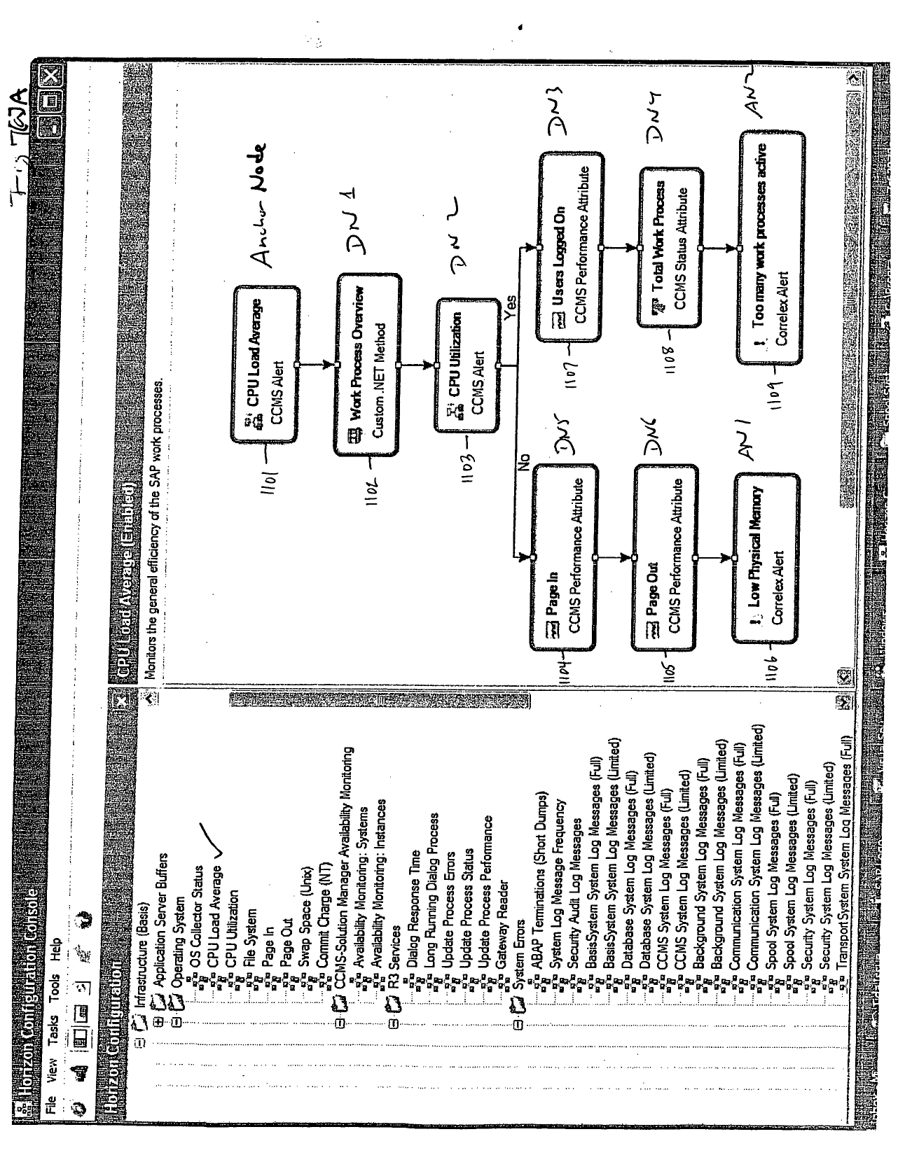

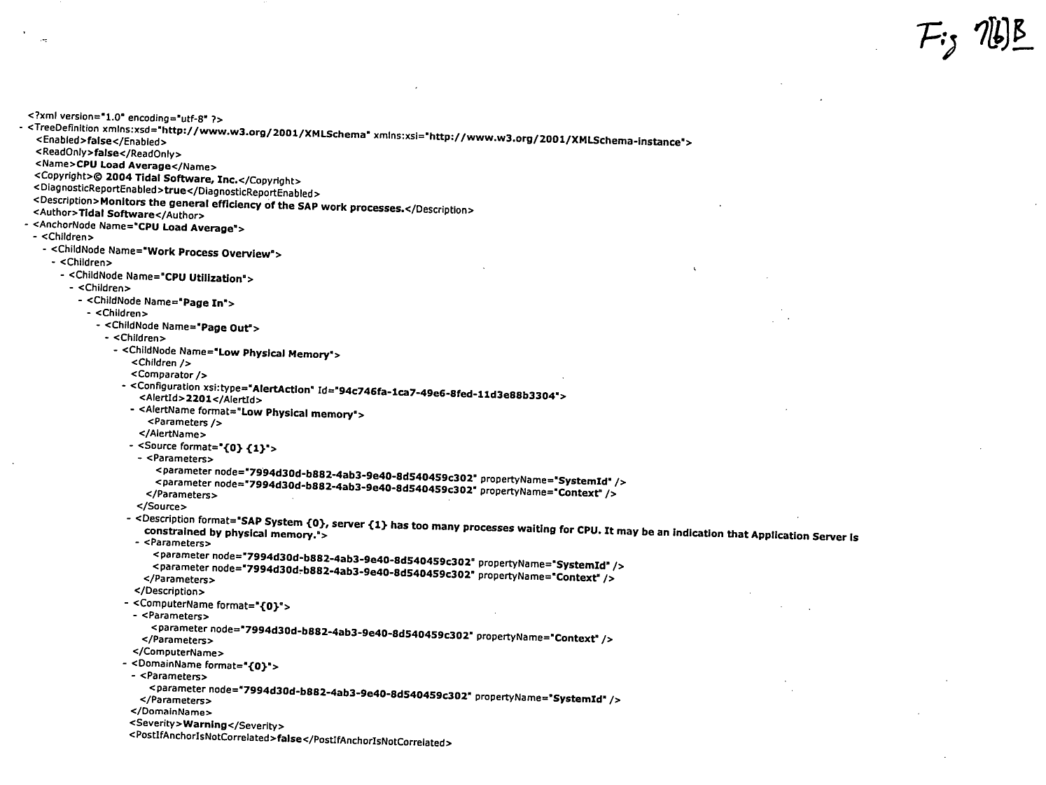

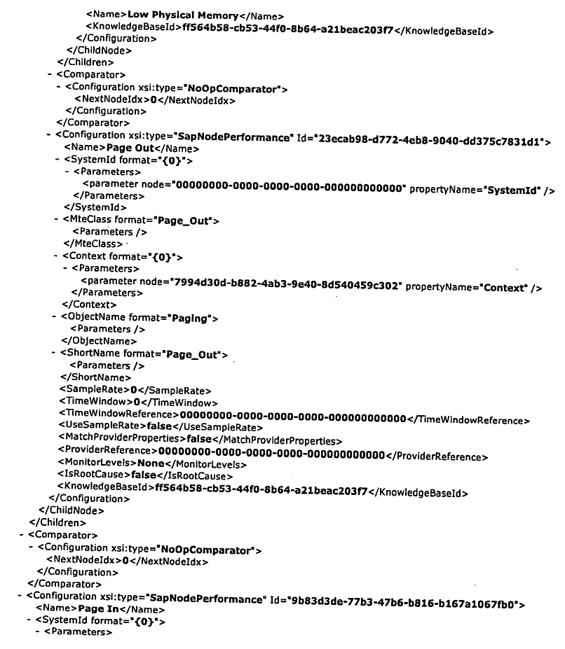

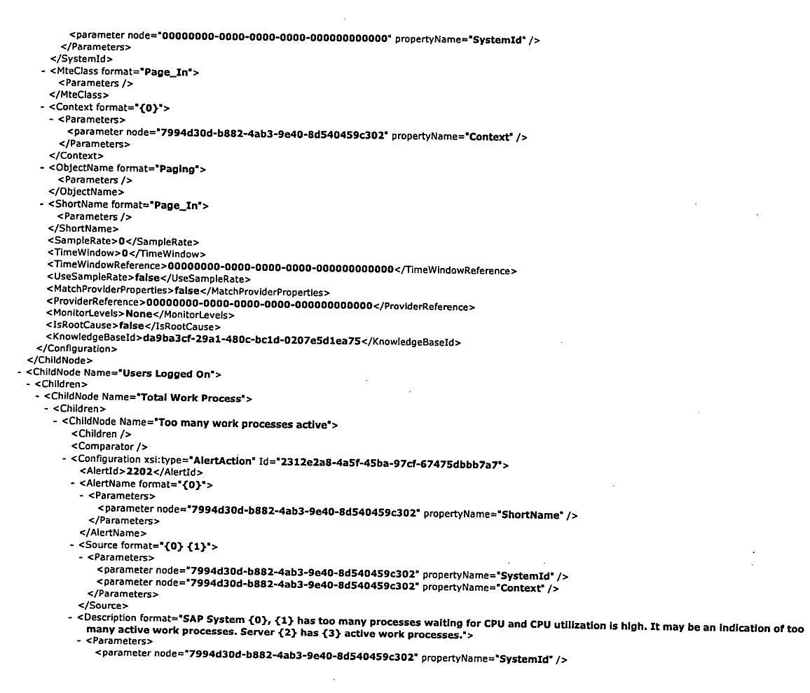

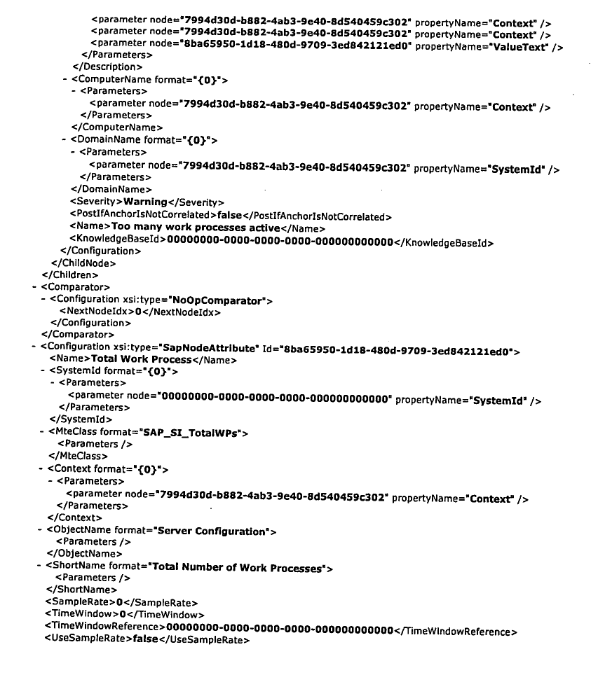

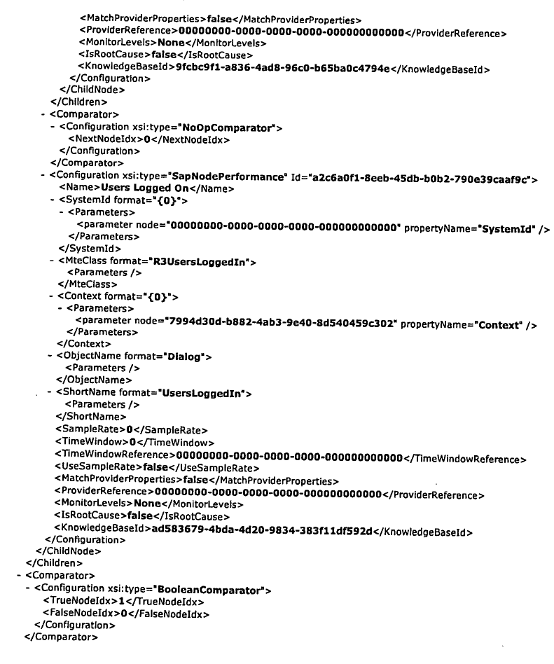

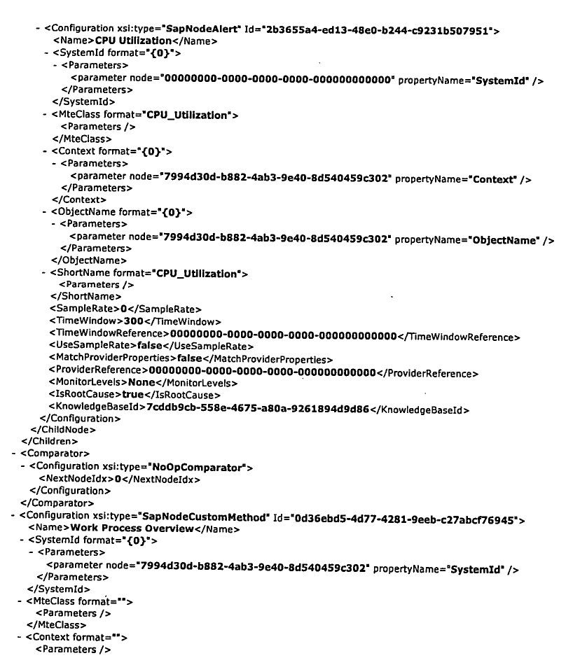

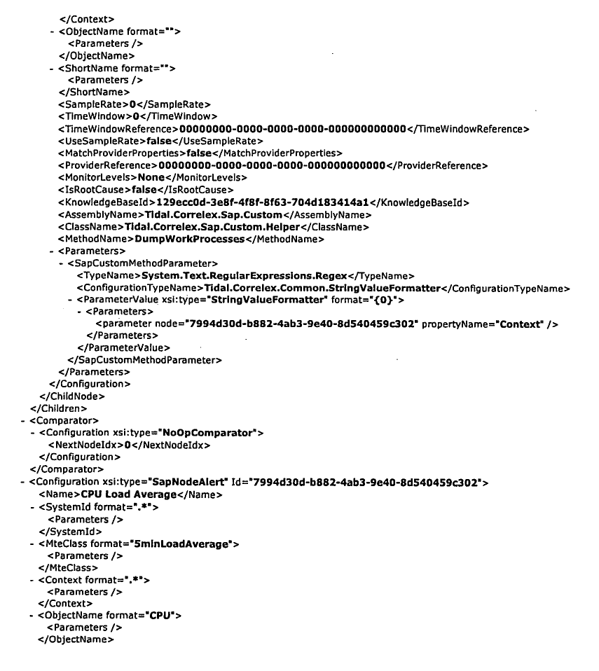

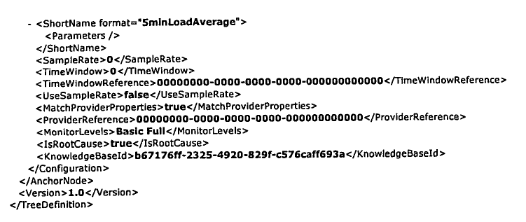

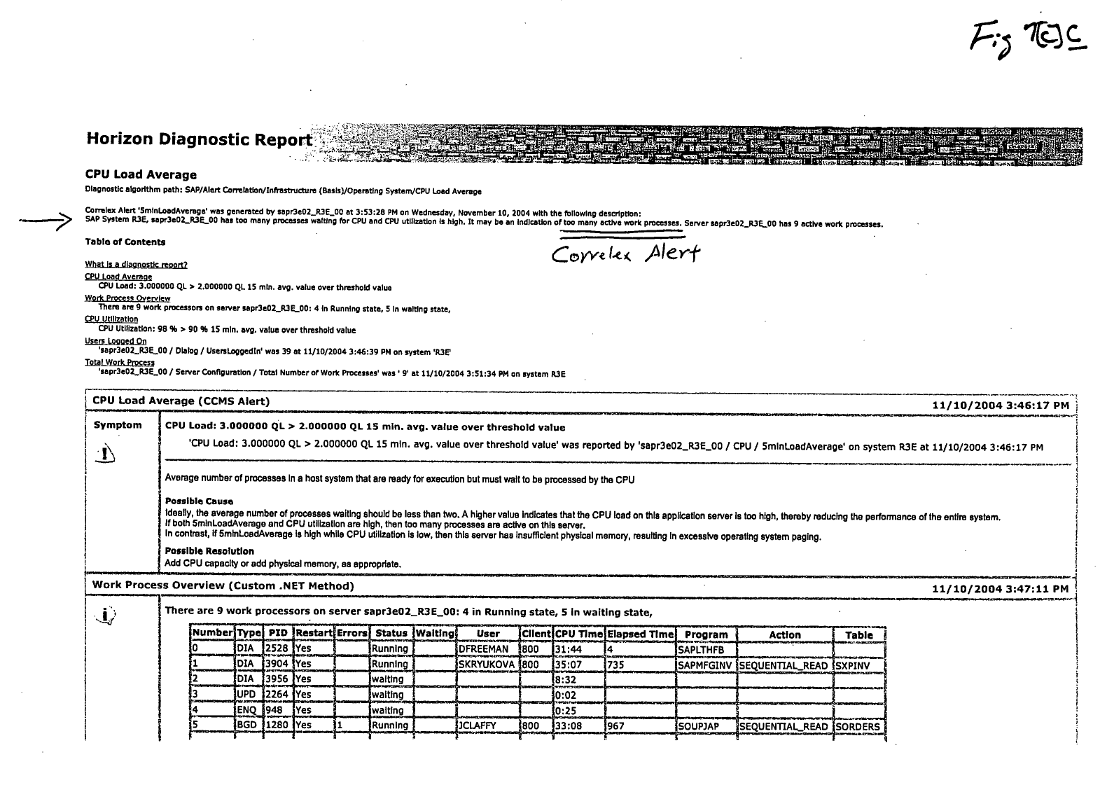

In an ideal world, data points associated with an event would appear more or less in order after the start of the monitoring of an event. For example, in FIG. 5B, a correlation tree having an anchor data node of T1 and four data nodes, D1, D2, D3, and D4, are shown. Action nodes A, B, and C represent correlated events. Let's define event X (as represented by action node B) as having a trigger data point T1 and three related data points, D1, D3, and D4. If T1 and the three data points occur within a certain time window, then event X is identified by action node B. In an ideal situation, as shown in timeline 1 of FIG. 5B, T1 would occur first and then the three data points would occur thereafter. In the real world, however, as shown in timeline 2 of FIG. 5C, some of the data points might occur before T1 occurs, and if a monitoring system does not capture and save the earlier-occurring data points, then the event may not be identified. The invention is able to capture data that occurs asynchronously and preserves relevant data points that might occur before the start of an alert or event.

In FIG. 5D a correlation tree with several data nodes is shown. Each data node has the following definitions: (1) requested data attributes, (2) time window, expressed in seconds, and (3) time window reference node. The requested data attributes tell a data node what kind of data to look for and from which data provider the data will be found. The time window indicates a time frame in which the data must be received. Finally, the requested data attributes must be received within a certain time window from another node. This node is called a time window reference node. However, note that the anchor data node has only the matching data attributes and no time window requirement.

For example, in node 2 N2 the requested data type is D1 and it has to occur with 300 seconds of the time window reference node or Node 1 N1. In Node 3 N3, the requested data type is D2 and it has to occur within 500 seconds of Node 1 N1. In Node 4 N4, the request data is D3, and it must occur within 300 seconds of N2. In Node 5 N5, the requested data is D4 and it has to occur within 300 seconds of N4. As shown, each lower level data node has a time window that is relative to the time of an ancestor node along the same branch of the tree.

As shown in FIG. 5D, once the correlation tree starts (i.e., an incoming data matches the data attributes, A1, of anchor node N1), the occurrence of data points D1, D3, and D4 within the proper time windows will result in a correlation alert, as shown in action node 2 A2. The proper sequence of data points may alternatively generate a correlex performance metric by reaching action node 1 A1 or a correlex event by reaching action node 3 A3.

In the FIG. 5E, data points from multiple data sources are captured S701, along with a data source identifier and the timestamp as provided by the data source. The data points are matched S702 against all the data nodes of the correlation trees loaded in the system. If the data point matches a data node of a currently executing correlation tree S703, it is tagged to the correlation tree and held in a data holding bin. An executing correlation tree will then wait for a request S704. When a request is made by the executing correlation tree, the data will be presented to the requesting data node for processing. If no request is made, the data is held in waiting until the executing correlation tree has terminated. When the executing correlation tree has ended the data in the holding bin is deleted S705. Not all data points that match an executing data tree will be requested by the tree. For example, a data point might match data nodes on a branch of the tree that does not execute.

If a data point matches a data node of a correlation tree that is not currently executing S706, the data is tagged as “of interest” to the correlation tree, and a lifespan is determined S707 based on the time window specified in the data node. The tagged data point is held in a data holding bin waiting for a data request S708 from the correlation tree. If a request is made, the data will be presented to the requesting data node for processing.

Periodically a clean-up program will execute to check the lifespan of the data points that are tagged to trees that are not executing. If the lifespan has been exceeded, then the data point is deleted S709, unless it is also tagged to a currently executing tree.

If a data point does not match any of the data nodes of the correlation trees then the data point is discarded S710. In one implementation of the invention, prior to discarding the data point, the invention will report the data to the system operator.

In FIG. 5F, an example data point is shown having a data attribute of D1 801, a data source time stamp 802, and a lifespan 803. The data point matches three correlation trees: Tree1, Node 2 804, which has a time window of 300 seconds 805; Tree 3, Node 4 806, which has a time window of 500 seconds 807; and Tree 2, Node 3 808, which has a time window of 400 seconds 809. If tree 1 804 and tree 3 806 are not executing, then the maximum lifespan of the data point assigned to them is 500 seconds.

If a data point is matched to a correlation tree that is executing, e.g., Tree 2 808, then the data point will be held in the data holding bin until it is requested by the executing tree. The data point will not be deleted even if the lifespan has expired. If no executing trees match the data point, then the data point will be marked for deletion once the lifespan has expired.

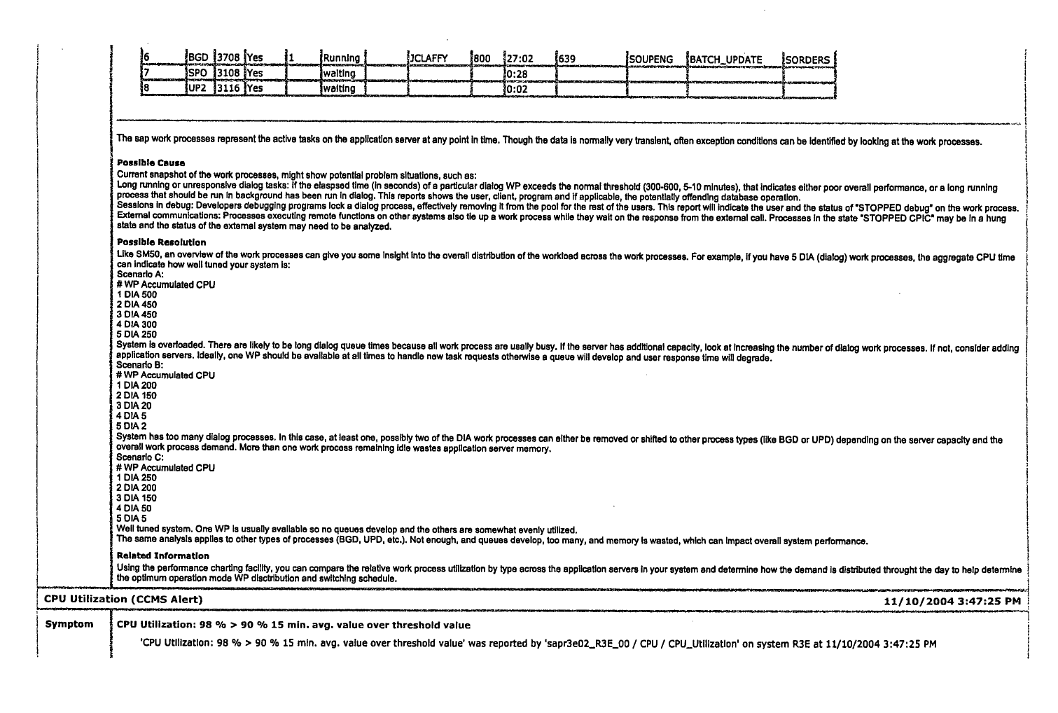

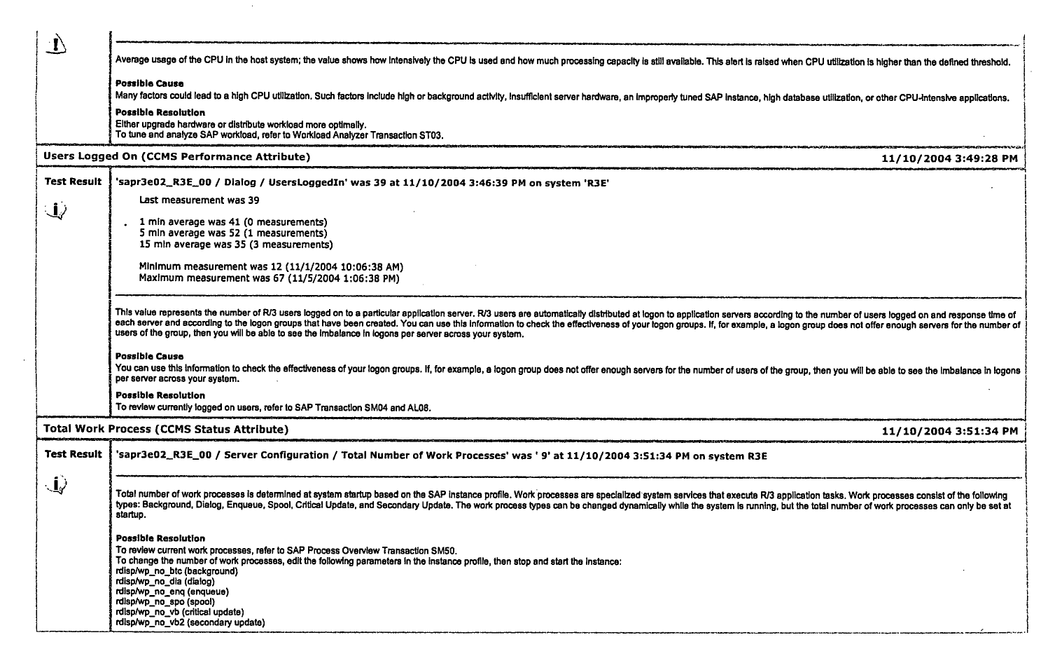

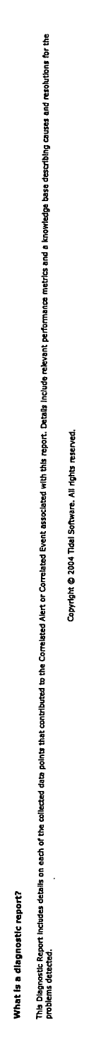

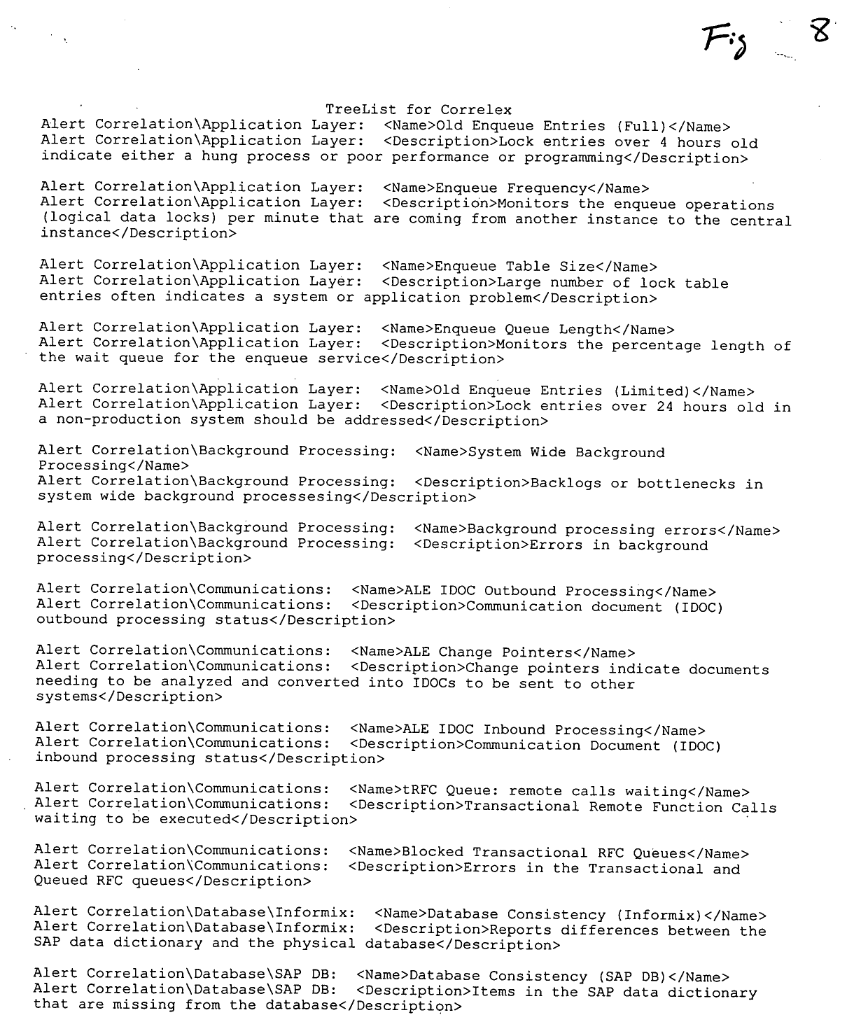

In FIG. 6A, the source provider is CCMS 901, which monitors an SAP database 902. The invention, as implemented in the form of a Correlex 903 that will (1) use the SAP communicator 904 to capture the data points from CCMS, (2) the correlation engine 905 match the data points to the correlation trees 906, and (3) the dispatcher 907 executes the correlation trees. The result of the tree execution and the correlation events are reported to the MOM transporter 908 that communicates with the MOM framework 909. The MOM framework 909 may have a program extension (e.g. Horizon extension) 910 that further processes data from the Correlex engine. Associated with the Correlex engine is a knowledge database 912 that provides further information and recommendations, in the form of diagnostic reports 911, to the system operator. Based on the types of alerts, events, or performance data identified by the correlation tree, a corresponding diagnostic report is generated.

In another embodiment of the invention shown in FIG. 6B, the source providers include a CCMS 1001, which monitors an SAP database 1002; a Siebel database 1003; a Tidal agent 1004, which monitors a Unix database 1005. However, the invention may also incorporate other database systems. The multiple and different types of data providers are supported and their data points are captured by the Correlex 1006. The Correlation Engine 1010 receives the data using a corresponding SAP communicator 1007, Siebel communicator 1008, or Unix communicator 1009.

The correlation engine 1010 match the data points to the correlation forest 1011, and the dispatcher 1012 executes the correlation trees. The results from the execution of the correlation trees are reported by a Tidal Enterprise Framework 1013, MOM transporter 1014, OpenView transporter 1015, AM transporter 1016, or Remedy transporter 1018 to multiple and different management frameworks such as: Horizon database 1018, MOM 1019, OpenView from HP 1020, AppManager from NetIQ 1021, and Remedy from BMC Software 1022. The different management frameworks may have a Horizon extension 1023, 1024, and 1025.

Associated with the Correlex engine is a knowledge database 1027 that provides further information and recommendations, in the form of diagnostic reports 1026, to the system operator. Based on the types of alerts, events, or performance data identified by the correlation tree, a corresponding diagnostic report is generated.

In the present invention, correlation trees may be displayed visually to the system operator. Each data node is displayed and shows the data attributes associated with it. The action nodes at the end of a tree branch show the type of correlation event that will be reported to the operator, such as a Correlex Alert, Correlex Event, or Correlex Performance Metric.

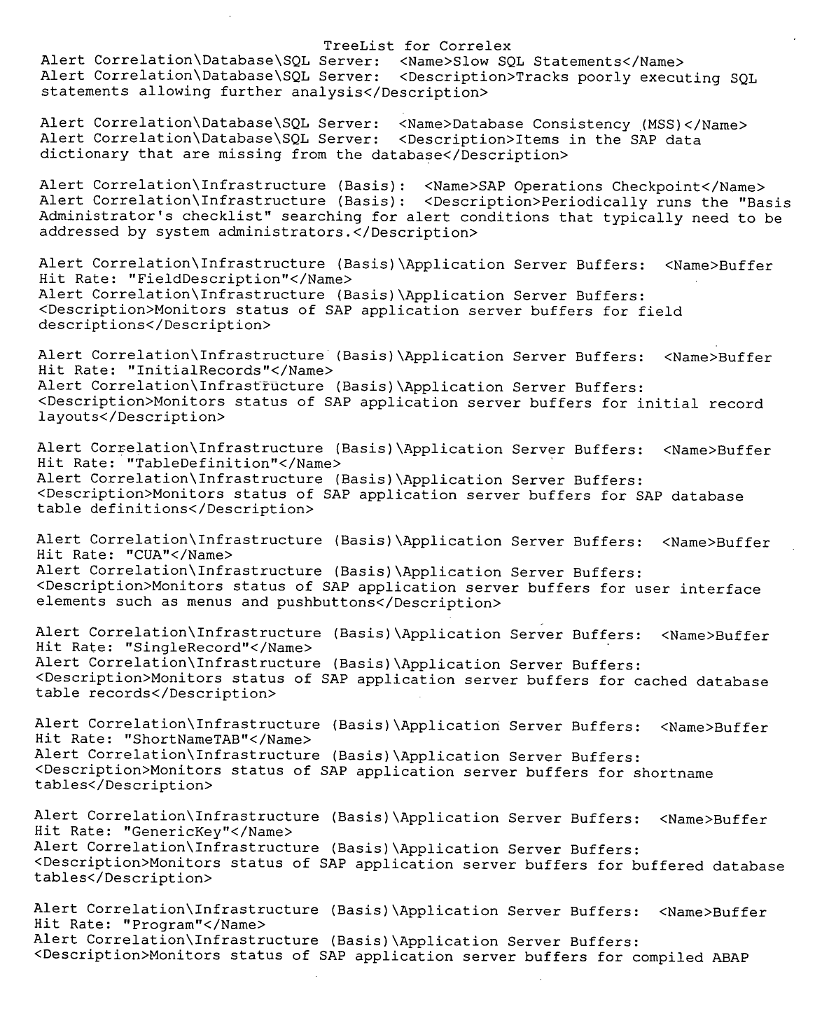

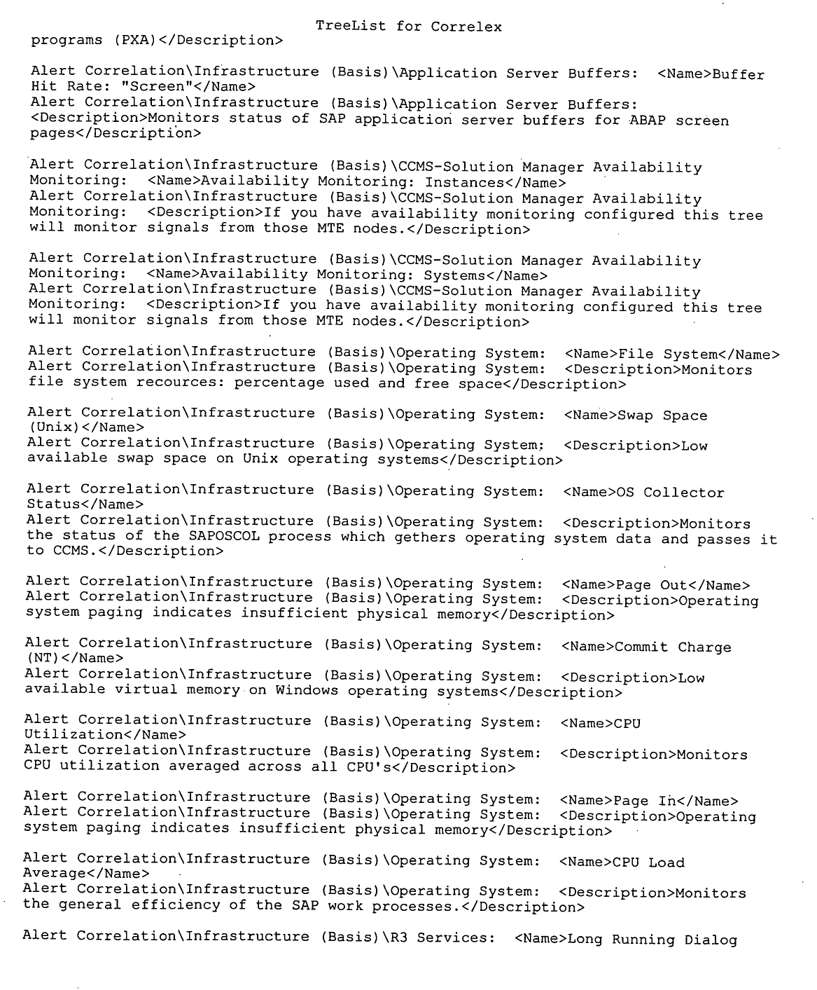

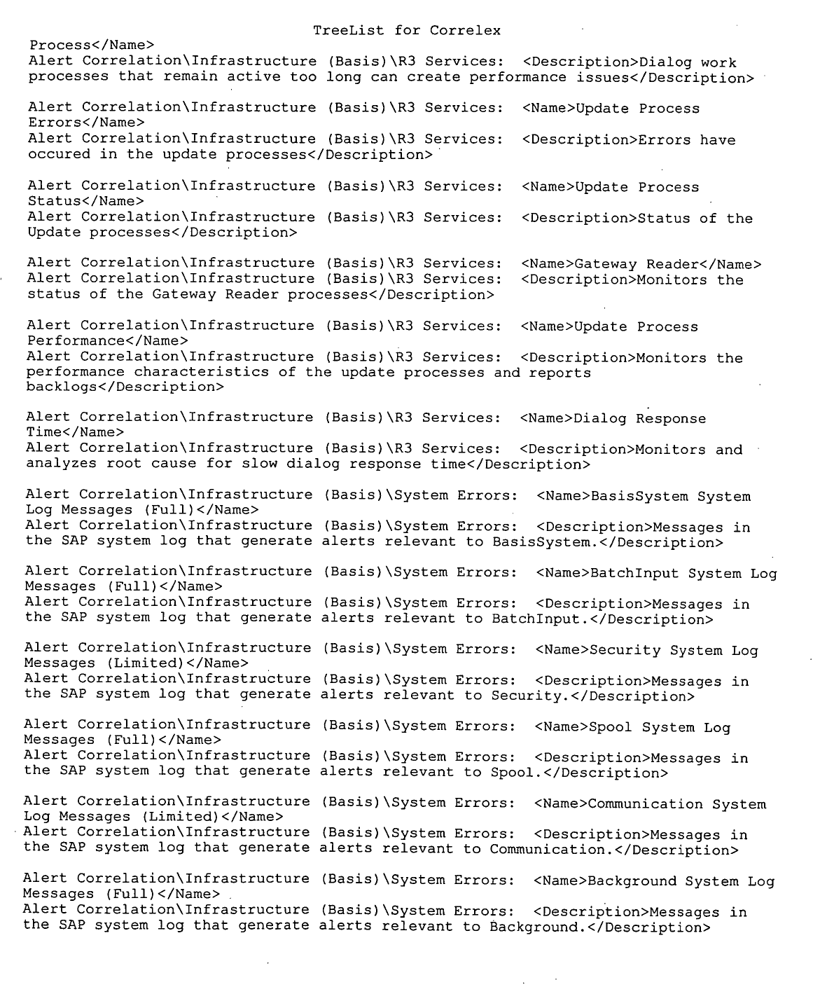

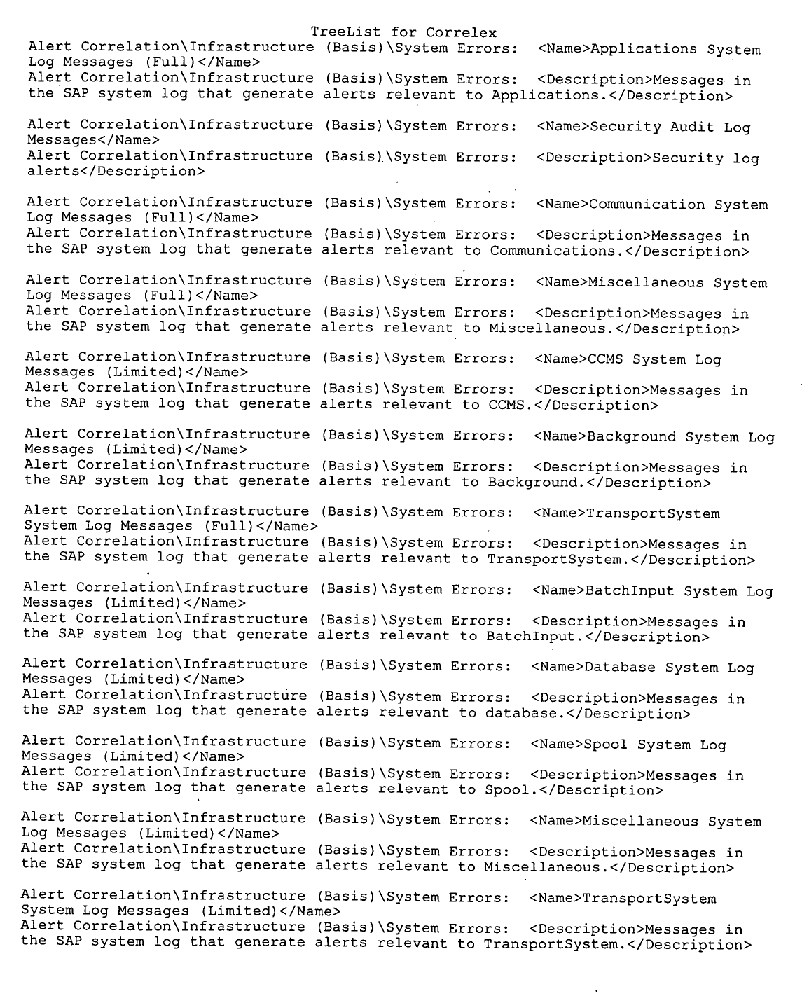

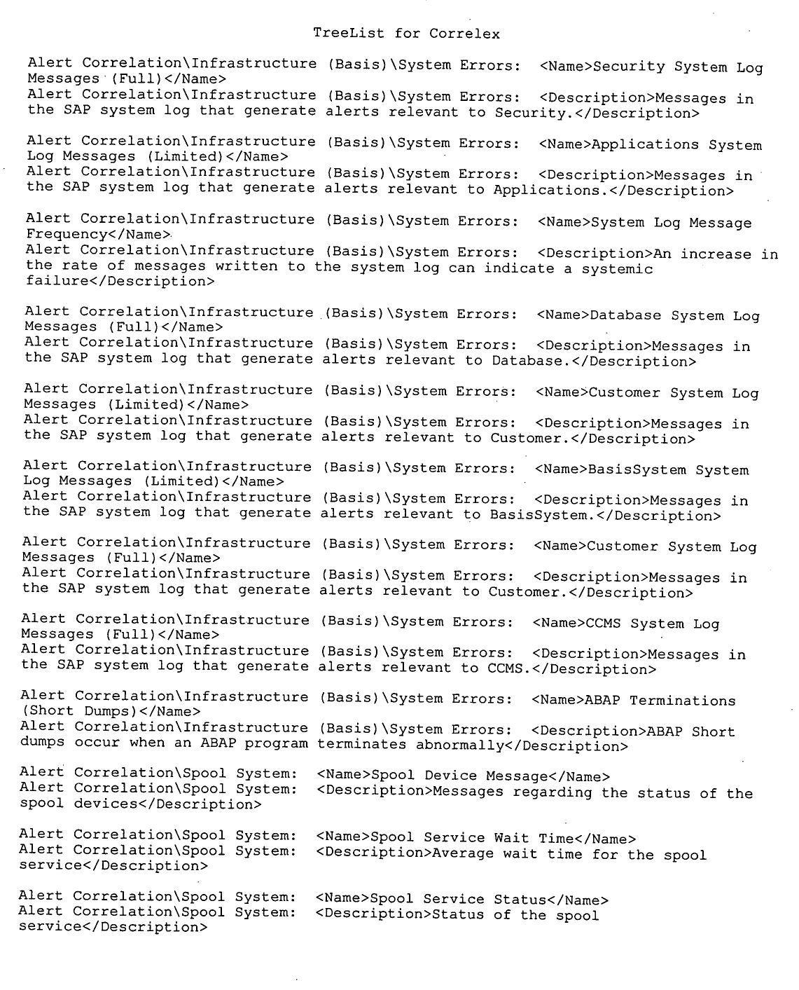

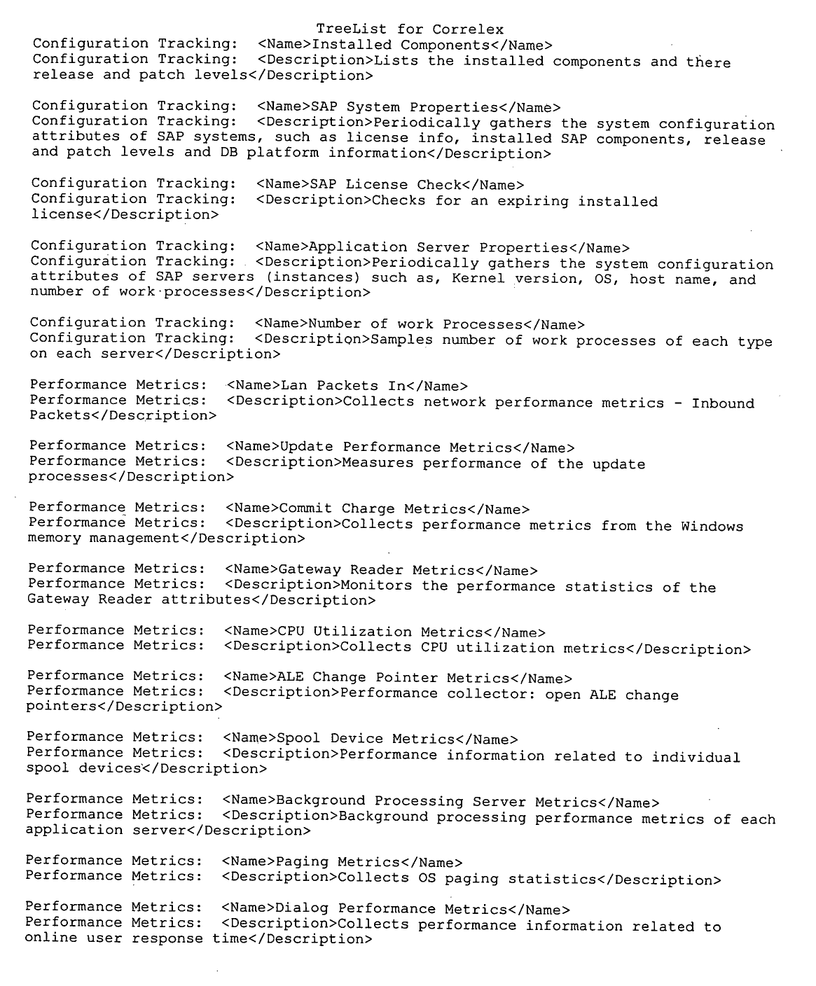

FIG. 7A shows the correlation tree associated with “CPU Load Average” which is used to monitor the operating system. The CCMS alert “CPU Load Average” is the anchor data node 1101 for the tree. When that alert is generated by CCMS and captured by the Correlex engine, the tree is started and the tree instance begins execution. In data node 1, a “Work Process Overview” 1102 request is initiated via a Custom .NET method. Data node 2 makes a request for CCMS alert “CPU Utilization” 1103. The result of the request determines which way to proceed down the decision tree.

If such alert is not available within a certain time window (as specified in data node 2), then a branch to data point 5 occurs, whereby a request for CCMS Performance attribute “Page In” 1104 is initiated. Next, in data node 6, a request for CCMS Performance Attribute: “Page Out” 1105 is issued. Finally, a Correlex Alert is issued for “Low Physical Memory” 1106.

If the CCMS alert for “CPU Utilization” 1103 does occur within a specified time window, then the tree will branch to data node 3, wherein a request for CCMS Performance Attribute: “Users Logged On” 1107 is initiated, followed by “Total Work Process” 1108 as requested by data node 4. Finally, a Correlex Alert of “Too Many Work Processes Alive” 1109 is reported, along with a diagnostic report, as shown in FIG. 7C.

Correlation trees are defined using the XML programming language. FIG. 7B is the hardcopy printout of the definition associated with the correlation tree of FIG. 7A.

As shown in FIG. 7B, the nodes of a correlation tree are defined, along with the node's parameters and data attributes. In addition, the “time window” and the “time window reference” for each data node are specified. The data analysis to be performed on the request data and the resulting tree logic branch are also specified for each node.

FIG. 7C is an example diagnostic report associated with the correlation tree of FIG. 7A. As shown, the “CPU Load Average” correlation tree is triggered by the CCMS alert: “CPU Load Average”. Next, a “Work Process Overview” is requested, which is performed using a custom .NET method. The result of the data request is shown in FIG. 7C. Diagnostic information is provided with the data to aid the operator in the analysis of the situation. Next, a “CPU Utilization” is requested and depending on whether a CCMS alert was issued or not, corresponding information is provided. In this report, a CCMS alert was issued, indicating that the CPU utilization was higher than the default threshold. As a result, CCMS performance attributes for “User Logged On” and “Total Work Processes” are requested and reported on the diagnostic report. Finally, the report shows that a Correlex Alert was generated, notifying the operator that “Too Many Work Processes Active” event has occurred.

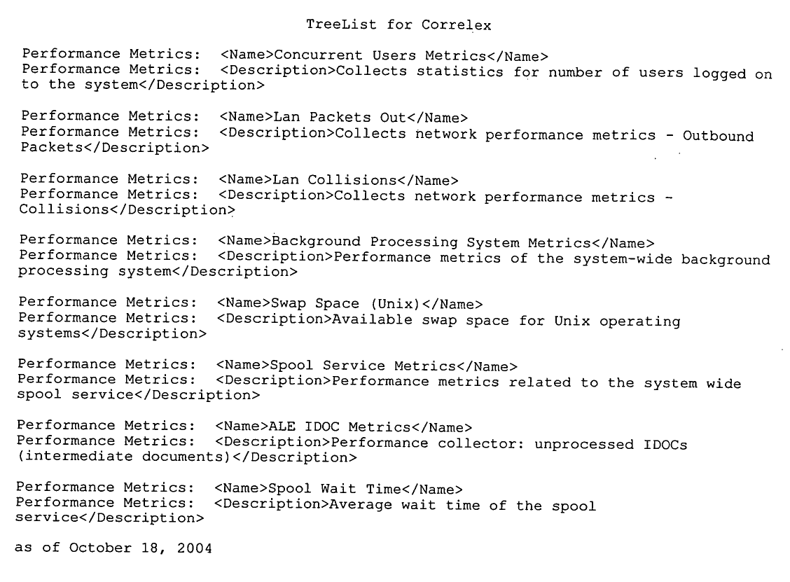

FIG. 8 is a listing of the correlation trees currently implemented in the Product. Currently there are over 90 correlation trees available with the Product. Correlation trees are provided with the Product; however, customers may define their own correlation trees to monitor their specific applications and computing environment.

What is claimed is:

1. A method for monitoring data sources from one or more providers comprising:
the one or more data providers providing data to a processor;
the processor comprising
a communicator for receiving the data from one or more data providers;
a processor engine which compares the data to one or more correlation trees;
a transporter for processing data from the processor and provides a diagnostic report, recommendations, and additional information.

2. The method of claim 1, wherein the processor engine matches the data to a node in the one or more correlation trees that is an anchor node, which causes one of the correlation trees to be executed.

3. The method of claim 2, wherein the processor engine proceeds to a next node branching from the anchor node of the executed correlation tree;
the processor engine determines a lifespan of the next node when the next node is a data node; and
the data node is executed when the data matches the data node.

4. The method of claim 3, wherein specific data is requested by the processor engine in accordance with the executed data node; and
an analysis of the specific data received or not received by the correlation engine determines a next node branching from the executed data node on the correlation tree that the correlation engine proceeds to and executes.

5. The method of claim 3, wherein the processor engine deletes the data if the lifespan expires without matching the data to the next node.

6. The method of claim 4, wherein the processor engine repeats the steps of claim 4 if the next node is a data node.

7. The method of claim 4, wherein the processor engine generates a diagnostic report, recommendations, or additional information for a system operator when the next node is an action node.

8. The method of claim 2, wherein the processor engine repeatedly compares the data to the nodes of the correlation tree; and
the correlation engine proceeds to subsequent branches of the correlation tree, based on an analysis of the specific data requested according to a corresponding data node and the specific data received or not received, until an action node is reached; and
when the action node is reached the processor engine generates a diagnostic report, recommendations, or additional information for a system operator.

9. The method of claim 8, wherein the processor engine captures and processes the data asynchronously.

10. The method of claim 1, wherein the processor engine matches the data with a node, which is a data node, the data point is tagged and held in a data holding bin until the data is requested.

11. The method of claim 10, wherein the processor engine matches the data to a node in the one or more correlation trees that is an anchor node, which causes one of the correlation trees to be executed.

12. The method of claim 11, wherein the processor engine proceeds to a next node branching from the anchor node of the executed correlation tree;
the processor engine determines a lifespan of the next node when the next node is a data node; and
the data node is executed when the data matches the data node.

13. The method of claim 12, wherein specific data is requested by the processor engine in accordance with the executed data node; and
an analysis of the specific data received or not received by the correlation engine determines a next node branching from the executed data node on the correlation tree that the correlation engine proceeds to and executes.

14. The method of claim 12, wherein the processor engine deletes the data if the lifespan expires without matching the data to the next node.

15. The method of claim 13, wherein the processor engine repeats the steps of claim 13 if the next node is a data node.

16. The method of claim 11, wherein the processor engine repeatedly compares the data to the nodes of the correlation tree; and
the correlation engine proceeds to subsequent branches of the correlation tree, based on an analysis of the specific data requested according to a corresponding data node and the specific data received or not received, until an action node is reached; and
when the action node is reached the processor engine generates a diagnostic report, recommendations, or additional information for a system operator.

17. The method of claim 16, wherein the processor engine captures and processes the data asynchronously.

18. The method of claim 1, wherein the correlation engine does not match the data to an anchor node or data point the data is deleted.

19. A system for monitoring data sources from one or more providers comprising:
the one or more data providers providing data to a processor;
the processor comprising
a communicator for receiving the data from one or more data providers;
a processor engine which compares the data to one or more correlation trees;
a transporter for processing data from the processor and provides a diagnostic report, recommendations, and additional information.

20. The system of claim 19, wherein the processor engine matches the data to a node in the one or more correlation trees that is an anchor node, which causes one of the correlation trees to be executed.

21. The system of claim 20, wherein the processor engine proceeds to a next node branching from the anchor node of the executed correlation tree;
the processor engine determines a lifespan of the next node when the next node is a data node; and
the data node is executed when the data matches the data node.

22. The system of claim 21, wherein specific data is requested by the processor engine in accordance with the executed data node; and
an analysis of the specific data received or not received by the correlation engine determines a next node branching from the executed data node on the correlation tree that the correlation engine proceeds to and executes.

23. The system of claim 21, wherein the processor engine deletes the data if the lifespan expires without matching the data to the next node.

24. The system of claim 22, wherein the processor engine repeats the steps of claim 22 if the next node is a data node.

25. The system of claim 22, wherein the processor engine generates a diagnostic report, recommendations, or additional information for a system operator when the next node is an action node.

26. The system of claim 20, wherein the processor engine repeatedly compares the data to the nodes of the correlation tree; and
the correlation engine proceeds to subsequent branches of the correlation tree, based on an analysis of the specific data requested according to a corresponding data node and the specific data received or not received, until an action node is reached; and
when the action node is reached the processor engine generates a diagnostic report, recommendations, or additional information for a system operator.

27. The system of claim 26, wherein the processor engine captures and processes the data asynchronously.

28. The system of claim 19, wherein the processor engine matches the data with a node, which is a data node, the data point is tagged and held in a data holding bin until the data is requested.

29. The system of claim 28, wherein the processor engine matches the data to a node in the one or more correlation trees that is an anchor node, which causes one of the correlation trees to be executed.

30. The system of claim 29, wherein the processor engine proceeds to a next node branching from the anchor node of the executed correlation tree;
the processor engine determines a lifespan of the next node when the next node is a data node; and
the data node is executed when the data matches the data node.

31. The system of claim 30, wherein specific data is requested by the processor engine in accordance with the executed data node; and
an analysis of the specific data received or not received by the correlation engine determines a next node branching from the executed data node on the correlation tree that the correlation engine proceeds to and executes.

32. The system of claim 30, wherein the processor engine deletes the data if the lifespan expires without matching the data to the data node.

33. The system of claim 31, wherein the processor engine repeats the steps of claim 13 if the next node is a data node.

34. The system of claim 29, wherein the processor engine repeatedly compares the data to the nodes of the correlation tree; and
the correlation engine proceeds to subsequent branches of the correlation tree, based on an analysis of the specific data requested according to a corresponding data node and the specific data received or not received, until an action node is reached; and
when the action node is reached the processor engine generates a diagnostic report, recommendations, or additional information for a system operator.

35. The system of claim 34, wherein the processor engine captures and processes the data asynchronously.

36. The system of claim 19, wherein the correlation engine does not match the data to an anchor node or data point the data is deleted.

37. A method for monitoring data sources from one or more providers comprising:
a processor receiving data from one or more sources;
the processor compares the data to nodes in a plurality of correlation trees;
the plurality of correlation trees each comprising an anchor node, one or more data nodes, and one or more action nodes;
when a combination of nodes is matched within a time specified to the correlation tree, a diagnostic report, recommendations, and additional information associated with the combination of the nodes matched is reported to one or more system operators.

38. The method of claim 37, wherein the anchor node is the first node in one of the plurality of correlation trees and contains requested data attributes that triggers the execution of the correlation tree;
the one or more data nodes contains requested data attributes, time window data, and time window reference node,
and the requested data attributes must be received within the time, indicated by the time window data, from when the time window reference node was received; and
the one or more action nodes indicates a diagnostic report, recommendations, and additional information that will be reported to the system operator according to the action node traversed in the correlation tree.

39. A method for monitoring data sources from one or more providers comprising the steps of:
(a) capturing data from the data sources;
(b) matching the data from the data sources to correlation tree definitions;
(c) executing the correlation tree;
(d) if there is a correlation detected the correlation is reported and provided, otherwise the data is discarded.

40. A method for monitoring data sources from one or more providers comprising:
A correlation engine that creates a correlation tree by categorizing nodes as an anchor node defining certain data attributes, an data node that can perform data request and analysis of data, or an action node that is used to report correlated alert, even, or performance metric;
A processor that captures data points from the data sources;
The processor performs the steps of
(a) comparing the data points to the data nodes in the correlation tree and the processor flags the data node if there is a match;
(b) when an anchor node is matched the processor flags a tree instance and moves to a next node in the correlation tree;
(c) the data node requests specific data and moves to another next node dependant on whether or not the specific data is received;
(d) step (c) is repeated until an action node is reached;
(e) the sequence of nodes followed in the correlation tree reported and a diagnostic report is created and recommendations are made;
(f) the sequence of the nodes followed in the correlation tree and the diagnostic report is provided to a system operator; and
(g) the data points that were not part of the correlation tree or that have expired are deleted.
